(19) United States
(12) Patent Application Publication
(10) Pub. No.: US 2026/0300631 A1
(43) Pub. Date: Oct. 1, 2026

(54) SYSTEMS AND METHODS FOR QUESTION ANSWERING SCORING IN LARGE LANGUAGE MODELS

(71) Applicant: Salesforce, Inc., San Francisco, CA (US)

(72) Inventors: Shrikant Kendre, Palo Alto, CA (US); Juan Carlos Niebles Duque, Mountain View, CA (US); Austin Xu, San Francisco, CA (US); Shafiq Rayhan Joty, San Jose, CA (US); Honglu Zhou, Palo Alto, CA (US); Michael S. Ryoo, New York, NY (US)

(21) Appl. No.: 19/367,316

(22) Filed: Oct. 23, 2025

Related U.S. Application Data
(60) Provisional application No. 63/779,512, filed on Mar. 28, 2025.

(51) Int. Cl. G06F 40/30

(52) U.S. Cl. CPC G06F 40/30

(57) ABSTRACT

Embodiments described herein provide a QA framework that combines sentence-level semantic analysis with keyword-level semantic matching and/or exact keyword matching as feedback to iteratively update the generation and training process. For example, a lightweight generative model may be used to precompute synthetic answers based on ground-truth answers (to evaluation questions) and a formatting style of natural language model responses. The synthetic answers are used to generate semantic scores (e.g., sentence level) that measure embedding similarities between the model responses and the synthetic answers. Separately, the ground-truth answers to the evaluation questions are used to generate keyword scores (e.g., keyword level) that measure lexical similarity (e.g., exact match) and/or keyword-level semantic matching. The semantic scores (e.g., sentence level) and the keyword scores (e.g., keyword level) are integrated together for a combined score, which can be used as a reward signal in reinforcement learning to refine the evaluated model.

### CROSS REFERENCE(S)

The instant application is a nonprovisional of and claims priority under 35 U.S.C. 119 to U.S. provisional application No. 63/779,512, filed Mar. 28, 2025, which is herein expressly incorporated by reference in its entirety.

### TECHNICAL FIELD

The embodiments relate generally to machine learning systems for question answering (QA) scoring in large language models (LLMs), and more specifically to a QA framework integrating both semantic and keyword scores for building and refining LLMs.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Question answering (QA) tasks are often used to evaluate the performance of large language models (LLMs). High-quality evaluations are important for building and refining LLMs. Traditional question-answering evaluation metrics (e.g., ROUGE and BLEU) primarily assess lexical similarity (e.g., how much the model-generated answer can match with the ground-truth answer via exact word matching), neglecting the critical semantic understanding required for evaluating language, image, and video question answering tasks. Other evaluation metrics such as BERTScore embodies keyword-level semantics, but overlook sentence-level meaning and ignore lexical similarity. Finally, LLM evaluators can be computationally expensive while subject to bias or, evaluation variance, and hallucinations. There is therefore a need for a computationally efficient evaluation and training framework without the high computational costs associated with GPU-intensive generative evaluators.

### BRIEF DESCRIPTION OF THE DRAWINGS

FIG. 1 shows an example operation of an LLM-based AI agent, according to embodiments of the present disclosure.

FIG. 2 is a simplified diagram illustrating a Question Answering (QA) framework, according to some embodiments.

FIGS. 3A-3B illustrates various QA examples demonstrating that the QA framework of FIG. 2 provides improved performance over other evaluation metrics, according to some embodiments.

FIG. 4A is a simplified diagram illustrating a computing device implementing the QA framework described in FIGS. 2-3, according to some embodiments.

FIG. 4B is a simplified diagram illustrating a neural network structure, according to some embodiments.

FIG. 5 is a simplified block diagram of a networked system suitable for implementing the QA framework described in FIGS. 2-3 and other embodiments described herein.

FIG. 6 is an example logic flow diagram illustrating a method of enhancing question-answering in a neural network based language model based on the framework shown in FIGS. 2-3, according to some embodiments.

FIGS. 7-8 provide data illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

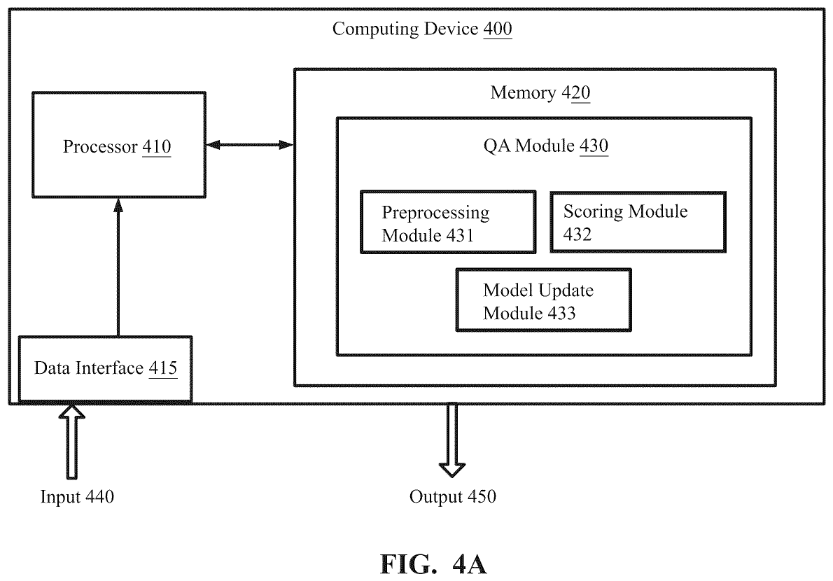

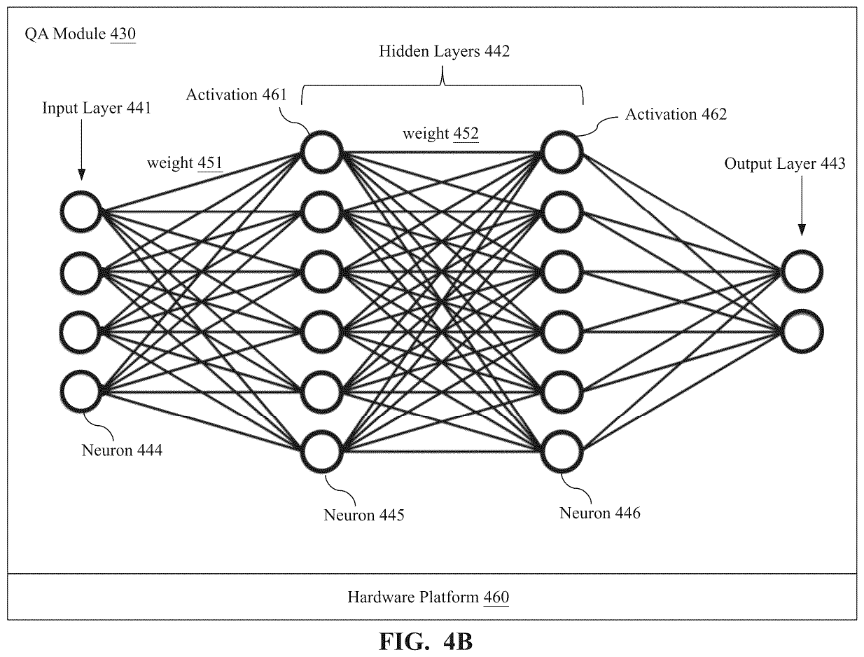

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 4B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

As LLMs become more advanced, model answers have grown to be more nuanced, making exact match in question answering (QA) prone to both false positives and false negatives. Existing QA evaluators employ exact keyword match or learned embedding-based metrics to assess similarity between the predicted response and the ground-truth. While these metrics may capture high-level similarity between the model response and ground-truth, they may miss fine-grained details crucial to answer correctness (e.g., “The cat is on a chair” vs. “The cat is under a chair”), resulting in lower correlation with human judgments. Further, using LLMs as generative to prompt larger capable LLMs or finetune smaller LLMs specifically for evaluation come with increased computational costs. These types of generative evaluators have relatively high latency and are prone to bias, evaluation variance, and hallucinations.

In view of the need to improve QA performance of LLMs, embodiments described herein provide a QA framework that combines sentence-level semantic analysis with keyword-level semantic matching and/or exact keyword matching as feedback to iteratively update the generation and training process. For example, a lightweight generative model may be used to precompute synthetic answers based on ground-truth answers (to evaluation questions) and a formatting style of natural language model responses. The synthetic answers are used to generate semantic scores (e.g., sentence level) that measure embedding similarities between the model responses and the synthetic answers. Separately, the ground-truth answers to the evaluation questions are used to generate keyword scores (e.g., keyword level) that measure lexical similarity (e.g., exact match) and/or keyword-level semantic matching. The semantic scores (e.g., sentence level) and the keyword scores (e.g., keyword level) are integrated together for a combined score. In this way, the combined score is generated without relying on the original question or context, thus improves computational efficiency. The combined score can be used as a reward signal in a reinforcement learning pipeline, enabling iterative refinement of the evaluated model based on QA performance. The combined score can also be integrated during answer generation, such as by selecting and returning the highest-scoring answer to the user among multiple candidate answers generated by the LLM.

Embodiments described herein provide a number of benefits. The QA framework integrates both semantic scores (e.g., sentence level) and keyword scores (e.g., keyword level) to capture fine-grained details, resulting in more accurate evaluation of model outputs. The QA framework also achieves significantly lower computational burden (e.g., lightweight enough to run on a CPU during evaluation) by precomputing key components, allowing for fast lookup and lightweight inference. Further, the QA framework is evaluated across text, image, and video-based QA datasets, demonstrating robustness across multiple modalities, which is unlike prior evaluation metrics which often focus on a single domain. By integrating these scoring and evaluation techniques in model training and answer generation, the QA framework improves the performance and reliability of neural network technology in LLMs.

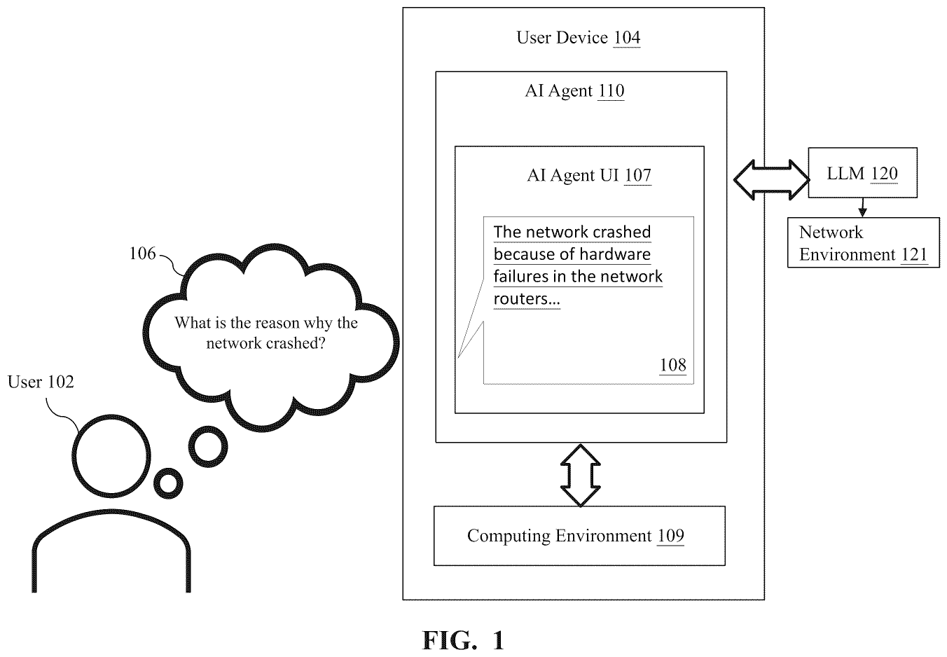

FIG. 1 shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent “What is the reason why the network crashed?” 106.

In one embodiment, the AI agent 110 may process the task request 106 at an LLM 120 to understand its intent, extracting key information such as the task type, desired outcome, and any specific constraints in order to generate a response. In an embodiment, the LLM 120 may be an evaluated model 208 later described. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106 and any system prompt.

The response 108 may include answers, instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104. The LLM 120 may also output to a network environment 121 for further processing (e.g., executing tasks in the network environment 121 and/or propagating instructions to network equipment in the network environment 121).

For example, when the user 102 requests answers to network failures, the LLM 120 may output an answer 108 on AI Agent UI 107. In this case, the LLM 120 may further generate a code script to execute on a computing environment 109 of the user device 104 (such as a network management application, a browser application, a programming terminal application, etc.) to retrieve network traffic log, analyze the traffic log, and identify anomaly, etc. and/or interface with APIs of other applications to run diagnostics and/or the like.

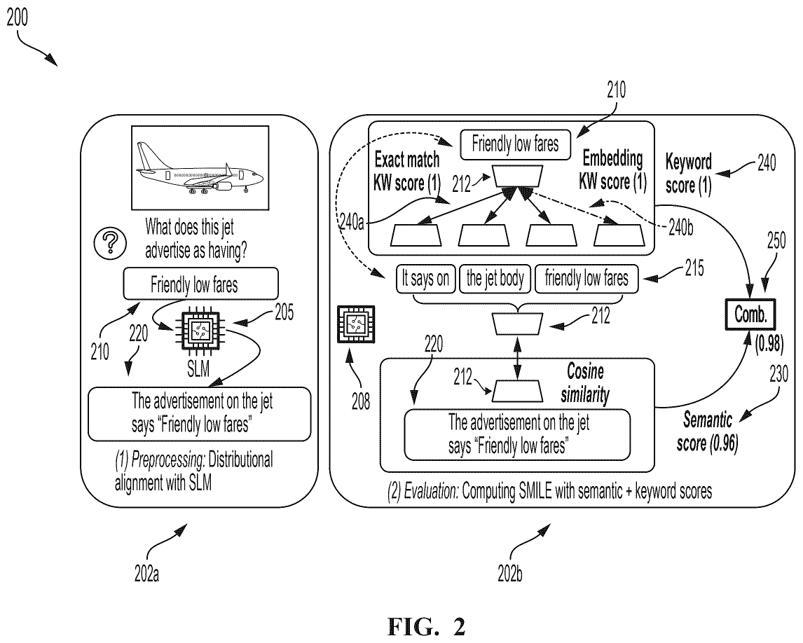

In this way, the LLM-based AI agent may facilitate end-to-end workflow to automate the task request 106. However, the quality and correctness of the automated tasks largely depend on the accuracy of the LLM answer outputs (e.g., whether the AI Agent 110 correctly identified the reason of network failures). If the LLM answer outputs are incorrect, the automated tasks may also be incorrect. There is thus a need to accurately evaluate question answering (QA) in LLMs for building, training, and refining these models. The present disclosure provides a QA framework integrating both semantic and keyword scores, enabling accurate, interpretable, and computationally lightweight evaluation compared to existing methods, and further supports the building and refinement of LLMs based on such evaluation, as further described with respect to FIGS. 2-8.

FIG. 2 is a simplified diagram illustrating a Question Answering (QA) framework 200, according to some embodiments. The framework 200 (or portions thereof) may also be referred to as a Semantic Metric Integrating Lexical Exactness (SMILE) framework. The framework 200 may include a preprocessing stage 202a, an evaluation stage 202b, and a model update stage (not explicitly shown).

In the preprocessing stage 202a, the QA framework 200 includes using a synthetic answer generator 205 to generate synthetic answers 220 from question-answer pairs. Each question-answer pair includes a test question (e.g., “What does this jet advertise as having”) and an associated gold answer 210 (e.g., “Friendly low fares”). The gold answer 210 refers to the ground truth answer y*, which is typically short (e.g., a single word or short phrase). The ground truth y* may be suboptimal as a metric for semantic scoring, as model responses tend to be more verbose. That is, there may be a stylistic distribution gap between model responses and the ground truth y*. As such, the processing stage 202a translates the gold answer 210 into a synthetic answer 220 to bridge the distribution gap.

In one embodiment, the synthetic answers 220 are generated independently of any specific LLM being evaluated and are created prior to the generation of any model responses to be assessed. This means that the synthetic answers 220 do not depend on the outputs of the models under evaluation (e.g., evaluated model 208) and can be prepared in advance for the entire evaluation set. As a result, the evaluation process remains unbiased and efficient, allowing the same set of synthetic answers 220 to be reused for evaluating multiple models without the need for regeneration.

The synthetic answer generator 205 has a function “g” that takes as input the original question q and ground truth answer y* to output a synthetic answer \tilde{y}=g(y*, q). The synthetic answer \tilde{y} aligns stylistically with model responses, which is typically more verbose, but reflects the ground-truth answer content. The synthetic answer generation may be performed only once, prior to test-time, per evaluation set. As a result, synthetic answers may be pre-stored in memory and used for any subsequent evaluations, further reducing computational demands. The synthetic answer generator 205 can be a lightweight small language model (SLM), such as a 3B parameter model. The synthetic answer generator 205 may be implemented on a single graphics processing unit (GPU) requiring less than 10 GB of VRAM. In an embodiment, the synthetic answer generator 205 is a smaller model than the model to be evaluated (e.g., evaluated model 208).

In the evaluation stage 202b, the QA framework 200 evaluates a model response 215 based on both the gold answer 210 and the synthetic answer 220. The model response 215 is generated by an evaluated model 208, which is not restricted to any specific domain. The evaluated model 208 can encompass a range of model types, including natural language QA (NLQA), visual QA (VQA), and/or video QA (VidQA). NLQA models, such as GPT-40, may generate answers based on textual context. VQA models, like LLaVA-1.5 7B, may answer questions about images. VidQA models, such as Qwen2.5-VL 3B Instruct, may answer questions about video content.

The model response 215 is evaluated using two separate measurements: (1) sentence-level semantic similarity, assessed against the synthetic answer 220, and (2) both semantic and lexical similarity at the keyword level, assessed against the gold answer 210. These individual measurements are integrated to generate a combined score 250 that holistically evaluates model performance. Before measurements are performed, an embedding model e (referred to as embedding model 212) is used to generate embeddings of the synthetic answer 220, the gold answer 210, and the model answer 215. The embedding model 212 is a lightweight model that may run on a central processing unit (CPU) instead of a GPU. In an embodiment, the embedding model 212 is a smaller model than both the evaluated model 208 and the synthetic answer generator 205. In an embodiment, the embedding model 212 may be a model with less than 500M parameters, such as ember-v1, which has 335M parameters. Since the synthetic answer generator 205 running on GPU is deployed in the preprocessing stage 202a and the synthetic answers 220 are prepared in advance, the embedding model 212 may be deployed on standard hardware such that the evaluation stage 202b is wholly run on CPU, saving computational resources. Notably, the QA evaluation is done without the test question and context at test time, relying only on the model response 215, the gold answer 210, and the synthetic answer 220.

Keeping with the example shown, the evaluated model 208 may generate an answer “It says on the jet friendly low fares.” This response 215 may correspond to or be converted into embeddings (e.g., one or more numerical vectors) that capture semantic meaning and relationships between words (e.g., through embedding model 212). A first embedding (or first embeddings) corresponding to the entire response 215 may be assessed against the embedding of the synthetic answer 220 to generate a sentence-level semantic similarity score 230. The semantic similarity score 230, denoted as ss, is calculated as:

$${s}_{s} ( y , {y}^{⋆} ; e ) = sim ) e ( y ) , e ( \tilde{y} ) ) , \qquad ( 1 )$$

where sim denotes cosine-similarity:

$$sim ( x , y ) = \frac{〈 x , y 〉}{{‖ x ‖}_{2} {‖ y ‖}_{2}} ,$$

where y is the response 215 from the evaluated model 208, y is the synthetic answer 220. By using the synthetic answer 220 instead of the ground truth answer 210 for semantic similarity evaluation, the stylistic distribution gap previously described is avoided, making the semantic similarity more meaningful. In the present example, the semantic similarity score 230 is 0.96.

However, sentence-level semantic similarity by itself may not capture the entire nuances of evaluation. As such, a second embedding (or second embeddings) corresponding to partitioned segments of the response 215 are each assessed against the embedding of the gold answer 210 to generate a keyword similarity score 240. The second embedding (or second embeddings) may correspond to divided embeddings of the first embedding, where the second embedding is divided into sequences of “n” tokens for each divided embedding. Specifically, the partitioned segments are formed by dividing the response into sequences of “n” consecutive tokens, where “n” is determined by the number of words in the gold answer 210. In an embodiment, “n” is based on a total number of words of the gold answer 210. For example, the gold answer 210 “Friendly low fares” has 3 words, so each divided embedding corresponds to 3 words of the gold answer 210. Each divided embedding is assessed against the gold answer 210.

The keyword similarity score 240 may include a keyword lexical (or exact matching) similarity component 240a and a keyword semantic similarity component 240b. The keyword similarity score 240, denoted as sₗ, is calculated as:

$${s}_{ℓ} ( y , {y}^{⋆} ; e ) = \frac{1}{2} ( EM ( y , {y}^{⋆} ) + {max}_{i} \{ sim ( e ( {N}_{i} [ y ] ) , e ( {y}^{⋆} ) ) \} ) \qquad ( 2 )$$

where EM(y, y*)∈{0, 1} denotes an exact match score 240a between the answer y (i.e., response 215) from the evaluated model 208 and the ground-truth y* (i.e., gold answer 210). Nᵢ[y] denotes the i-th N-gram response y (i.e., the partitioned segments), each of which is evaluated against the ground-truth y* in a cosine-similarity analysis, and the max score corresponds to an embedding KW score 240b. In computing sₗ, the ground truth y* (i.e., gold answer 210) is used instead of the synthetic answer \tilde{y} (i.e., synthetic answer 220). This takes advantage of the fact that y* is typically a short phrase to compute two complementary scores. The exact match sub-score EM (denoted in FIG. 2 as Exact match KW score 240a) serves as a preliminary check for lexical answer correctness. In this case, the Exact match KW score is 1 because one of the partitioned segments (the last one) has an exact match with the gold answer “Friendly low fares.” In some embodiments, the exact match calculation includes an n-gram overlap comparison that gives partial credit when there is not exact string match.

However, exact (or even partial credit) match may be too stringent for synonym-like answers (e.g., “cat” vs. “kitten”). As a result, the N-gram embedding similarity sub-score (denoted as Embedding KW score 240b) uses the maximum of the N-gram similarities used as a proxy for how directly the response contains the answer. The Embedding KW score 240b may be calculated by performing a cosine-similarity analysis similar to the one performed to calculate the semantic score. The difference here is that the cosine-similarity analysis is performed for each partitioned segment, and the maximum score is taken as the Embedding KW score. In this case, the Embedding KW score is 1 because of the exact match. The combination of the Exact match and Embedding KW sub-scores 240a and 240b define the keyword similarity score 240 that accurately trades off the strictness of exact lexical match. Although the each of these sub-scores are equally weighted in the present example, the present disclosure is not limited thereto. Depending on if exact keyword matching is more or less important than semantic keyword evaluation, the weights of each sub-score can be adjusted accordingly (e.g., 0.3 (Exact match KW score)+0.7 (Embedding KW score)).

Finally, the semantic similarity score 230 and the keyword similarity score 240 are integrated together to form a combined score 250 (also referred to as SMILE score). As described herein, SMILE stands for Semantic Metric Integrating Lexical Exactness. The combined score 250, denoted as s_{SMILE}, is calculated as:

$${s}_{SMILE} ( y , {y}^{⋆} ; e , w ) = \frac{w}{2} \cdot {s}_{s} ( y , \tilde{y} ; e ) + \frac{( 1 − w )}{2} \cdot {s}_{ℓ} ( y , {y}^{⋆} ; e ) , \qquad ( 3 )$$

where w∈(0,1) is some user-specified weight. The combined score 150 is a weighted average of the semantic and keyword similarity scores 230 and 240. The weighting mechanism allows users to express their preferences: those who are more inclined towards exact match may place higher emphasis on sₗ, whereas those who value higher responses whose meaning is closest with the ground-truth may place a higher emphasis on ss. In the present embodiment, the emphasis is equally weighted, resulting in a combined score of 0.98 (i.e., 0.5(1)+0.5(0.96)).

In the model update stage (not explicitly shown), the combined score 250 may be used to compute a gradient objective for training the model 208. For example, the model 208 may be put in a reinforcement learning framework; and the combined score 250 may be used as a reward signal for reinforcement learning during training. Parameters (e.g., weights) of the evaluated model 208 may be updated based on the gradient objective, and the evaluated model 208 may generate an updated response based on the updated parameters. As the evaluated model 208 iteratively updates its parameters based on this objective, it can subsequently generate improved responses.

The combined score 250 may also be leveraged during the answer generation process itself. For example, when the evaluated model 208 produces multiple candidate answers for a given question, the framework 200 may select and return in real time the candidate with the highest combined score 250. This approach enables the evaluated model 208 to prioritize responses that are more likely to align with human judgment and evaluation criteria.

Further, the evaluated model 208 can engage in self-improvement by iteratively preferring and learning from higher-scoring answers over lower-scoring ones. This self-learning mechanism allows the model to continuously refine its outputs, effectively integrating the evaluation metric into both the training and inference stages for enhanced answer quality and alignment with desired evaluation standards.

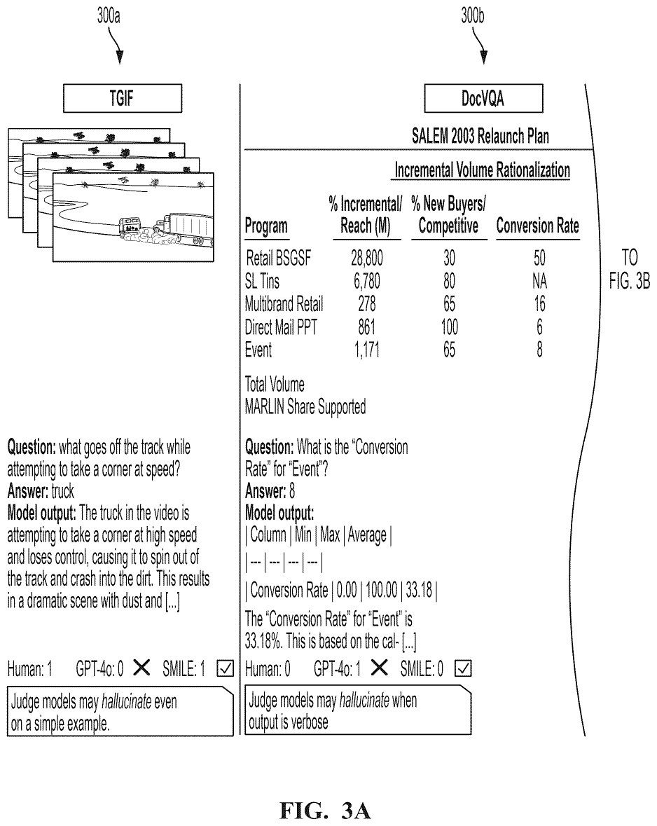

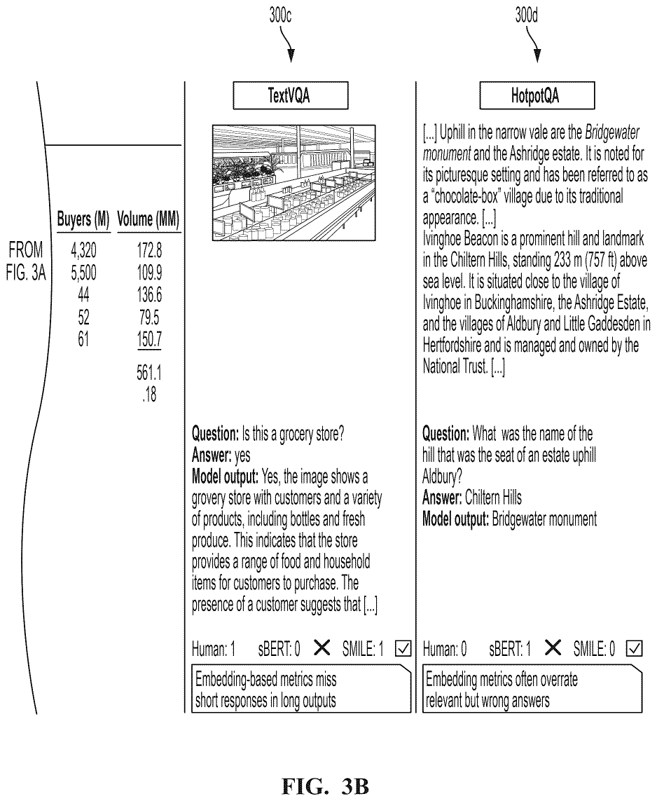

FIGS. 3A-3B illustrates various QA examples demonstrating that the QA framework 200 of FIG. 2 provides improved performance over other evaluation metrics, according to some embodiments. Columns 300a and 300b illustrate failure modes when using LLMs (e.g., GPT-40) as QA evaluators. In column 300a, given an input video, the GPT-40 evaluator hallucinates an incorrect label even for relatively simple samples, whereas the QA framework 200 (or SMILE) correctly evaluates the model output in alignment with human judgement. In column 300b, the GPT-40 evaluator is subject to concreteness bias, a known judge model bias, where the model is tricked by a response that includes verbose concrete artifacts, like the table the model generated. In contrast, the QA framework 200 (or SMILE) correctly evaluates the model output, again matching human judgement.

Columns 300c and 300d illustrate failure modes when using embedding-based models (e.g., sBERT) as QA evaluators. In column 300c, the sBERT evaluator misses short responses embedded within long outputs, where overly verbose model responses can mislead semantic similarity metrics, as much of the output is irrelevant to the simple “yes response.” Conversely, column 300d illustrates that when model responses are short but semantically relevant, these metrics are prone to false positives. In both columns 300c and 300d, the QA framework 200 (or SMILE) correctly evaluates the model output, matching human judgement. The framework 200 described above allows for a hallucination-free evaluation metric that produces more accurate evaluations than existing methods.

### Computer and Network Environment

FIG. 4A is a simplified diagram illustrating a computing device implementing the QA framework described in FIGS. 2-3, according to some embodiments. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for QA module 430 that may be used to implement and/or emulate the systems and models, and/or to implement any of the methods described herein. QA module 430 may receive input 440, such as input questions and corresponding ground-truth answers (e.g., as input data for the preprocessing stage 202a) via the data interface 415, and generate an output 450 which may be a combined score 250 (e.g., as output data from the evaluation stage 202b). Additionally, or alternatively, the QA module 430 may generate an output 450 which may be an updated response from an evaluated model (e.g., output from the model update stage). The updated response may be generated utilizing the combined score 250 as a reward signal (e.g., intermediate output data from the evaluation stage 202b) for refining the evaluated model.

The data interface 415 may comprise a communication interface, a user interface (such as a voice input interface, a graphical user interface, and/or the like). For example, the computing device 400 may receive the input 440 from a networked database via a communication interface. Or the computing device 400 may receive the input 440 from a user via the user interface.

In some embodiments, the QA module 430 is configured to perform operations and calculations as described with respect to FIG. 2. The QA evaluation module 430 may further include submodules such as a preprocessing module 431, a scoring module 432, and a model update module 433. These submodules may implement the various respective stages of the QA framework 200 described in FIG. 2.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4B is a simplified diagram illustrating the neural network structure implementing (at least partially) the QA module 430 described in FIG. 4A, according to some embodiments. In some embodiments, the QA module 430 and/or one or more of its submodules 431-433 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as input questions and ground-truth answers. The number of nodes (neurons) in the input layer 441 may be determined by the dimensionality of the input data. Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the QA module 430 receives an input 440 of input questions and ground-truth answers and transforms the input into an output 450 of a combined score and/or updated response. This process may involve (1) preprocessing the input questions and ground-truths to generate synthesized answers 220 (e.g., via a lightweight language model), (2) generating a combined score 250 for each model response of an evaluated model 208 by calculating and integrating keyword and semantic scores based on the inputs and the synthesized answers 220, and/or (3) updating and refining the evaluated model by using the combined scores 250 as a gradient objective in various stages of training and/or inference. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the QA module 430 and/or one or more of its submodules 431-433 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a recurrent neural network, a convolutional neural network, and/or the like.

In one embodiment, the QA module 430 and its submodules 431-433 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, representing a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the QA module 430 and its submodules 431-433 may be implemented by hardware, software and/or a combination thereof. For example, the QA module 430 and its submodules 431-433 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the QA module 430 and its submodules 431-433 and/or any other neural network models onto hardware platform 460, the neural network based modules 430 and its submodules 431-433 may be optimized for deployment by converting it to a suitable format, such as ONNX or TensorRT, to improve performance and compatibility. Next, depending on the size and workload requirements for modules 430 and its submodules 431-433, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the QA module 430 and its submodules 431-433 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the QA module 430 and its submodules 431-433 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the QA module 430 and its submodules 431-433 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the QA module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based QA module 430 and one or more of its submodules 431-433 may be trained by iteratively updating the underlying parameters (e.g., weights 451, 452, etc., bias parameters and/or coefficients in the activation functions 461, 462 associated with neurons) of the neural network based on a loss and/or a gradient objective (e.g., based on the combined score 250). For example, during forward propagation, the training data such as input data 440 are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding gold answer 210 and/or synthetic answer 220) from the training data (or generated therefrom), to compute a loss function that measures the discrepancy between the predicted output and the expected output (e.g., exact match, cosine similarity, etc. to generate combined score 250). For example, the loss function may be cross entropy, MMSE, and/or the like. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based QA module 430 and one or more of its submodules 431-433 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward (e.g., based on combined score 250) with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

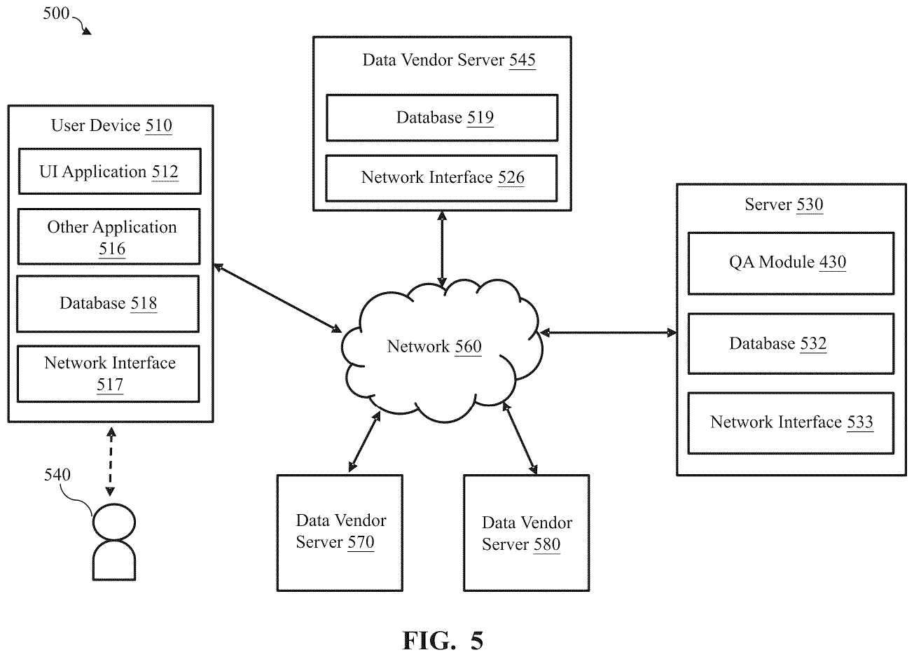

In some embodiments, QA module 430 and its submodules 431-433 may be housed at a centralized server (e.g., computing device 400) or one or more distributed servers. For example, one or more of QA module 430 and its submodules 431-433 may be housed at external server(s). The different modules may be communicatively coupled by building one or more connections through application programming interfaces (APIs) for each respective module. Additional network environment for the distributed servers hosting different modules and/or submodules may be discussed in FIG. 5.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. By utilizing the QA module 430, the trained neural network improves neural network technology by lowering computational cost in LLM evaluation and integrating sentence level and keyword level metrics for holistic evaluation.

FIG. 5 is a simplified block diagram of a networked system 500 suitable for implementing the QA framework 200 described in FIG. 2-3 and other embodiments described herein.

In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating a response or answer from the server 530 and display the message via the UI application 512. In other embodiments, user device 510 may include additional or different modules having specialized hardware and/or software as required.

In one embodiment, UI application 512 may communicatively and interactively generate a UI for an AI agent implemented through the QA module 430 (e.g., an LLM agent) at server 530. In at least one embodiment, a user operating user device 510 may enter a user utterance, e.g., via text or audio input, such as a question, uploading a document, and/or the like via the UI application 512. Such user utterance (e.g., question) may be sent to server 530, at which QA module 430 may generate a response through an evaluated model via the process described in FIG. 2. The QA module 430 may then cause a display of an evaluation score result and/or updated response at UI application 512 and interactively update the display in real time with the user utterance.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view the evaluation score result and/or updated response.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets (e.g., gold answers 210 and/or precomputed and prestored synthetic answers 220) to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the QA module 430 and its submodules described in FIG. 4A. In some implementations, QA module 430 may receive data from database 519 at the data vendor server 545 via the network 560 to generate output metrics and updated response. The generated output metrics and updated response may also be sent to the user device 510 for review by the user 540 via the network 560.

In one embodiment, an AI agent implementing the QA module 430 and its submodules described in FIG. 4A may be built based on an LLM as described in FIG. 4B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the QA module 430 and its submodules described in FIG. 4A may be implemented as a cloud-based AI agent which may be accessed by user device 510 via a chatbot application, a web application, customer support or SaaS applications. In another implementation, a client-side AI agent component may be delivered from the server 530 to user device 510 for local installation such that the client-side AI agent may be installed and runs directly on the user's device. Such local AI agent on the user device 510 may be available offline to adapt to privacy-sensitive applications. In another implementation, the AI agent implementing the QA module 430 and its submodules described in FIG. 4A may adopt a hybrid cloud and client-based structure to balance computing speed, cost and privacy. For example, a local AI agent may handle basic AI queries locally, but complex queries may be sent to server 530 to process.

The database 532 may be stored in a transitory and/or non-transitory memory of the server 530. In one implementation, the database 532 may store data obtained from the data vendor server 545. In one implementation, the database 532 may store parameters of the QA module 430. In one implementation, the database 532 may store previously generated output metrics, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Workflows

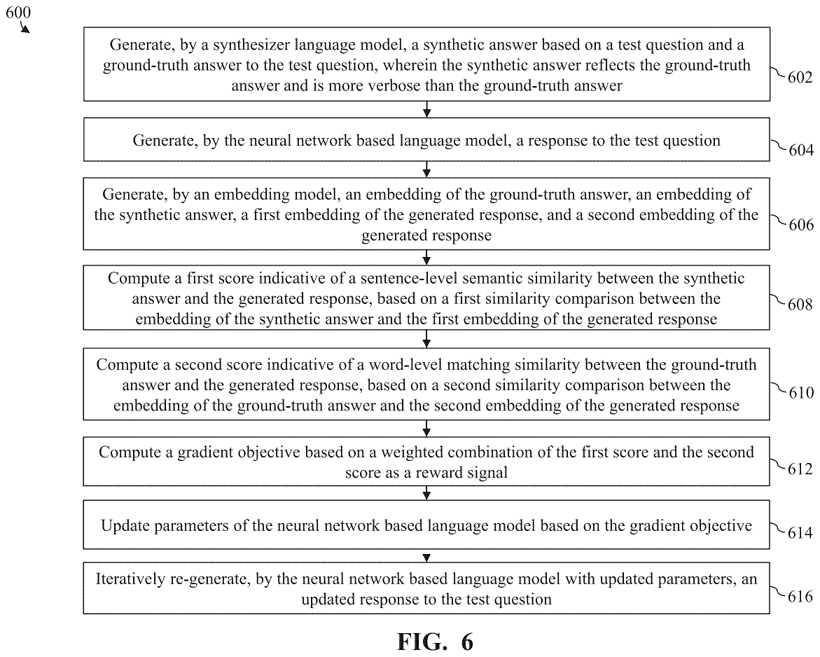

FIG. 6 is an example logic flow diagram illustrating a method of enhancing question-answering in a neural network based language model based on the framework shown in FIGS. 2-3, according to some embodiments.

One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the QA module 430 (e.g., FIGS. 4A and 5) that combines sentence-level semantic analysis with keyword-level semantic matching and/or exact keyword matching as feedback to iteratively update the generation and training process of an evaluated model.

In some embodiments, method 600 is performed by a system such as computing device 400, user device 510, server 530, or another device or combination of devices. Inputs (e.g., input test question and ground-truth answers) may be received via a data interface such as data interface 415, network interface 517, network interface 533, or via a data interface that is integrated with a device. For example, UI Application 512 may receive user inputs via a text input interface (e.g., keyboard), audio input (e.g., microphone), video interface (e.g., camera), or other interface for receiving user inputs (e.g., a mouse or touch display).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 602, the method 600 generates, by a synthesizer language model (e.g., synthetic answer generator 205), a synthetic answer (e.g., synthetic answer 220) based on a test question and a ground-truth answer (e.g., gold answer 210) to the test question, wherein the synthetic answer reflects the ground-truth answer and is more verbose than the ground-truth answer.

At step 604, the method 600 generates, by the neural network based language model (e.g., evaluated model 208), a response (e.g., model response 215) to the test question.

At step 606, the method 600 generates, by an embedding model (e.g., embedding model 212), an embedding of the ground-truth answer, an embedding of the synthetic answer, a first embedding of the generated response, and a second embedding of the generated response.

At step 608, the method 600 computes a first score (e.g., semantic similarity score 230) indicative of a sentence-level semantic similarity between the synthetic answer and the generated response, based on a first similarity comparison (e.g., cosine similarity) between the embedding of the synthetic answer and the first embedding of the generated response.

At step 610, the method 600 computes a second score (e.g., keyword similarity score 240) indicative of a word-level matching similarity between the ground-truth answer and the generated response, based on a second similarity comparison (e.g., exact match and/or cosine similarity) between the embedding of the ground-truth answer and the second embedding of the generated response.

At step 612, the method 600 computes a gradient objective based on a weighted combination (e.g., combined score 250) of the first score and the second score as a reward signal. At step 614, the method 600 updates parameters of the neural network based language model based on the gradient objective. At step 616, the method 600 iteratively re-generate, by the neural network based language model with updated parameters, an updated response to the test question. The updated neural network based language model may be deployed on a hardware platform as an AI agent.

In some embodiments, method 600 is applicable in a variety of applications. For example, the task request received by a neural network model (e.g., evaluated model 208) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 600, the neural network based artificial agent may improve technology in the respective technical field in healthcare and diagnostics, education and personalized learning, software development and code assistance, content creation, autonomous system (such as autonomous driving, etc.), and/or the like, by producing more accurate answers through composite scoring integrating both semantic and lexical analysis.

For example, method 600 may be further used to build a domain-specific agent, such as for healthcare, online learning, booking service, network diagnostics, and/or the like. A number of candidate LLMs may be evaluated using steps 602-608 with respective synthetic questions in a specific technical field and therefore an LLM is selected to build the AI agent. The agent architecture may comprise a retrieval layer for sourcing domain-specific data to synthesize additional domain-specific testing or training questions, the selected LLM for generation, and an orchestration layer for managing user interaction and workflow execution.

For example, when the task query includes a query to identify an information technology (IT) anomaly relating to a usage of an IT component such as a network gateway, a router, an online printer, and/or the like, by performing method 600 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may generate a code script such as a system-level command to cause an alert relating to the information technology anomaly to be displayed at a visualized user interface, or to block traffic from an Internet address associated with the identified anomaly. In this way, IT anomalies may be detected and alerted using the neural network based artificial agent in an efficient manner so as to improve network support technology.

### Example Results

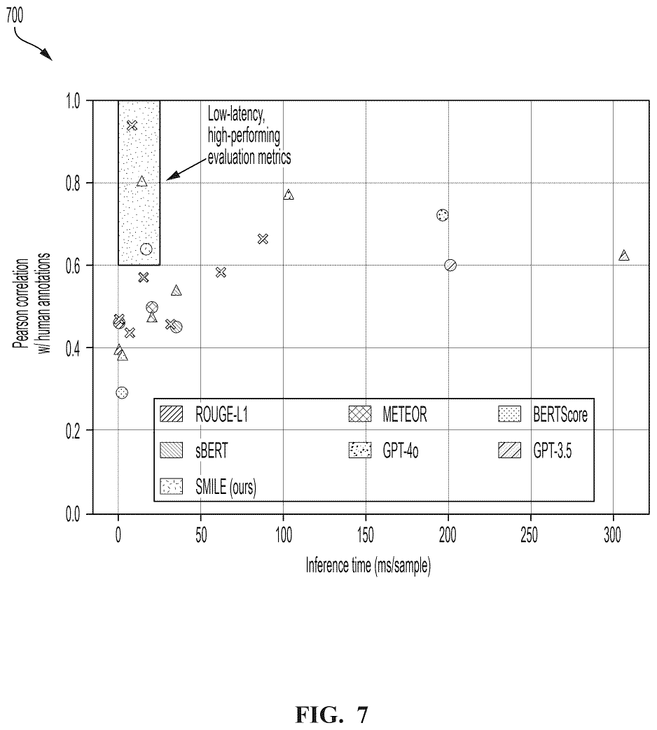

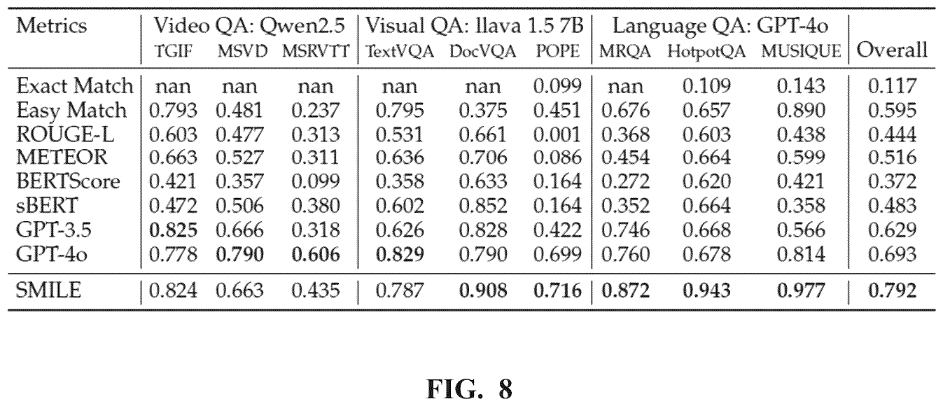

FIGS. 7-8 provide data illustrating exemplary performance of different embodiments described herein. FIG. 7 is a graph 700 illustrating how the QA framework 200 of FIG. 2 compares to other evaluators, according to an embodiment. The graph 700 illustrate results in various domains: natural language text for NLQA, visual image for VQA, and video for VidQA. As shown, the performance of evaluator ROUGE-L1, which focuses on lexical similarity and neglecting semantic similarities, is lower than the QA evaluation framework 200 (SMILE) across all domains. The performance of evaluator BERTScore, which focuses on keyword level semantics while overlooking sentence-level meaning, is lower than the QA evaluation framework 200 across all domains. And while the GPT-40 evaluator 206 has greater performance than ROUGE-L1 and BERTScore, its inference time is much longer than the QA evaluation framework 200 across all domains. Whereas in the QA evaluation framework 200, extracting representations from lightweight embedding models takes a fraction of the time required to generate a natural language output. This speed advantage can be boosted by pre-computing and storing the representations for synthetic answers e(\tilde{y}) and keyword representations e(y*) in the preprocessing stage 202a prior to the evaluation stage 202b. By storing pre-computed representations, at test time, only embedding representations involving the model response, e(y) and e(Ni[y]), need to be computed.

FIG. 8 presents the Pearson correlation of various evaluation metrics with human judgments across Video, Visual, and Language QA tasks. The metrics are listed from top (older, traditional evaluators) to bottom (newer, advanced evaluators). Exact Match and Easy Match (traditional, lexical-based metrics) show low to moderate correlation with human judgments, with Exact Match often failing to capture nuanced or semantically correct answers. ROUGE-L and METEOR (n-gram and lexical overlap metrics) perform slightly better but still lag behind more modern approaches. BERTScore and sBERT (embedding-based semantic similarity metrics) improve correlation, but are still limited, especially in handling verbose or nuanced responses. GPT-3.5 and GPT-40 (LLM-as-judge evaluators) achieve higher correlation, reflecting their advanced language understanding, but are compute-resource intensive and can be inconsistent or biased through hallucination errors. SMILE consistently achieves the highest correlation with human judgments across all modalities, outperforming both traditional metrics and LLM-based evaluators due to its method of combining semantic and lexical evaluation, offering both accuracy and efficiency.

The QA evaluation framework 200 has been explicitly tested in factual dataset settings, and as shown in FIGS. 7-8, demonstrates superior accuracy and performance over other model evaluators on a QA set. Additional testing may be performed to measure other aspects of the framework 200, such as the framework's performance in long-answer evaluations, and/or its effectiveness in training more accurate models using its more efficient and accurate composite scoring techniques.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of enhancing question-answering in a neural network based language model, the method comprising:
generating, by a synthesizer language model, a synthetic answer based on a test question and a ground-truth answer to the test question, wherein the synthetic answer reflects the ground-truth answer and is more verbose than the ground-truth answer;
generating, by the neural network based language model, a response to the test question;
generating, by an embedding model, an embedding of the ground-truth answer, an embedding of the synthetic answer, a first embedding of the generated response, and a second embedding of the generated response;
generating a first score indicative of a sentence-level semantic similarity between the synthetic answer and the generated response, based on a first similarity comparison between the embedding of the synthetic answer and the first embedding of the generated response;
generating a second score indicative of a word-level matching similarity between the ground-truth answer and the generated response, based on a second similarity comparison between the embedding of the ground-truth answer and the second embedding of the generated response; and
training the neural network based language model using a weighted combination of the first score and the second score as a reward signal; and
iteratively re-generating, by the neural network based language model with updated parameters from the training, an updated response to the test question.

2. The method of claim 1, wherein the first score is generated by performing a cosine similarity analysis between the embedding of the synthetic answer and the first embedding, the first embedding corresponding to an entirety of the generated response.

3. The method of claim 1, wherein the second score is generated by performing a cosine similarity analysis between the embedding of the ground-truth answer and the second embedding, the second embedding corresponding to divided embeddings of the generated response.

4. The method of claim 3, wherein the second embedding is divided into sequences of n tokens for each divided embedding, where n is based on a total number of words of the ground-truth answer.

5. The method of claim 3, wherein the second score is further generated by performing a lexical match analysis between the ground-truth answer and the response, wherein the lexical match analysis includes at least one of an exact match comparison or an n-gram overlap comparison.

6. The method of claim 1, wherein both the embedding model and the synthesizer language model are smaller in size than the neural network based language model.

7. The method of claim 1,
wherein the generating of the synthetic answer is a pre-processing step performed on a graphics processing unit (GPU),
wherein the generating of the embeddings and the computing of the first score, the second score, and the gradient objective are performed on a central processing unit (CPU).

8. The method of claim 1, wherein the synthetic answer is independent of the neural network based language model and is generated and pre-stored in memory before the generating of the response to the test question.

9. A system for enhancing question-answering in a neural network based language model, the system comprising:
a memory that stores one or more neural network models and a plurality of processor-executable instructions;
a communication interface that receives a test question and a ground-truth answer to the test question; and
one or more hardware processors that read and execute the plurality of processor-executable instructions from the memory, wherein the plurality of processor-executable instructions are configurable to cause the system to perform operations comprising:
generating, by a synthesizer language model, a synthetic answer based on the test question and the ground-truth answer, wherein the synthetic answer reflects the ground-truth answer and is more verbose than the ground-truth answer;
generating, by the neural network based language model, a response to the test question;
generating, by an embedding model, an embedding of the ground-truth answer, an embedding of the synthetic answer, a first embedding of the generated response, and a second embedding of the generated response;
generating a first score indicative of a sentence-level semantic similarity between the synthetic answer and the generated response, based on a first similarity comparison between the embedding of the synthetic answer and the first embedding of the generated response;
generating a second score indicative of a word-level matching similarity between the ground-truth answer and the generated response, based on a second similarity comparison between the embedding of the ground-truth answer and the second embedding of the generated response;
training the neural network based language model using a weighted combination of the first score and the second score as a reward signal; and
iteratively re-generating, by the neural network based language model with updated parameters from the training, an updated response to the test question.

10. The system of claim 9, wherein the first score is generated by performing a cosine similarity analysis between the embedding of the synthetic answer and the first embedding, the first embedding corresponding to an entirety of the generated response.

11. The system of claim 9, wherein the second score is generated by performing a cosine similarity analysis between the embedding of the ground-truth answer and the second embedding, the second embedding corresponding to divided embeddings of the generated response.

12. The system of claim 11, wherein the second embedding is divided into sequences of n tokens for each divided embedding, where n is based on a total number of words of the ground-truth answer.

13. The system of claim 11, wherein the second score is further generated by performing a lexical match analysis between the ground-truth answer and the response, wherein the lexical match analysis includes at least one of an exact match comparison or an n-gram overlap comparison.

14. The system of claim 9, wherein both the embedding model and the synthesizer language model are smaller in size than the neural network based language model.

15. The system of claim 9,
wherein the generating of the synthetic answer is a pre-processing step performed on a graphics processing unit (GPU),
wherein the generating of the embeddings and the computing of the first score, the second score, and the gradient objective are performed on a central processing unit (CPU).

16. The system of claim 9, wherein the synthetic answer is independent of the neural network based language model and is generated and pre-stored in memory before the generating of the response to the test question.

17. A non-transitory machine-readable medium comprising a plurality of instructions, executable by one or more processors, wherein the plurality of instructions are configurable to cause the one or more processors to perform operations comprising:
generating, by a synthesizer language model, a synthetic answer based on a test question and a ground-truth answer to the test question, wherein the synthetic answer reflects the ground-truth answer and is more verbose than the ground-truth answer;
generating, by a neural network based language model, a response to the test question;
generating, by an embedding model, an embedding of the ground-truth answer, an embedding of the synthetic answer, a first embedding of the generated response, and a second embedding of the generated response;
generating a first score indicative of a sentence-level semantic similarity between the synthetic answer and the generated response, based on a first similarity comparison between the embedding of the synthetic answer and the first embedding of the generated response;
generating a second score indicative of a word-level matching similarity between the ground-truth answer and the generated response, based on a second similarity comparison between the embedding of the ground-truth answer and the second embedding of the generated response;
training the neural network based language model using a weighted combination of the first score and the second score as a reward signal; and
iteratively re-generating, by the neural network based language model with updated parameters from the training, an updated response to the test question.

18. The medium of claim 17, wherein the first score is generated by performing a cosine similarity analysis between the embedding of the synthetic answer and the first embedding, the first embedding corresponding to an entirety of the generated response.

19. The medium of claim 17, wherein the second score is generated by performing a cosine similarity analysis between the embedding of the ground-truth answer and the second embedding, the second embedding corresponding to divided embeddings of the generated response.

20. The medium of claim 17, wherein the synthetic answer is independent of the neural network based language model and is generated and pre-stored in memory before the generating of the response to the test question.
